(19) United States
(12) Patent Application Publication
(10) Pub. No.: US 2026/0043364 A1
(43) Pub. Date: Feb. 12, 2026

(54) Durable Generator Power System and Method of Use

(71) Applicant: Axlom Energy Group, LLC, East Troy, WI (US)

(72) Inventors: Michael Schildt, Eagle, WI (US); Marlo Dl Benedetto, Big Bend, WI (US)

(21) Appl. No.: 19/293,591

(22) Filed: Aug. 7, 2025

Related U.S. Application Data
(60) Provisional application No. 63/681,469, filed on Aug. 9, 2024.

(51) Int. Cl. F02D 29/06; F02B 63/04; F02D 41/00; F02D 41/28

(52) U.S. Cl. CPC F02D 29/06; F02B 63/044; F02D 41/0002; F02D 2041/281; F02D 2200/02; F02D 2700/0205

(57) ABSTRACT

A dual-fuel variable speed load matching power generation system provides electrical power output to match an electric load and can operate completely independently of a central-type electrical power grid. The system includes an electrically controlled air and fuel, variable speed, dual-fuel, liquid-cooled engine and a liquid-cooled alternator that is configured to output an electrical supply between approximately 0.5 kW and 40 kW. The system controller is configured to modulate engine speed through both variable fuel flow and air flow into the engine. The speed of the engine may be controlled to control the output of the genset to meet prevailing electrical loads. The variable speed engine is configured to modulate between an operating speed of approximately 500 RPM to 3,600 RPM and has an average maintenance cycle of approximately 4,000 operating hours to 8,000 operating hours.

### CROSS-REFERENCE TO RELATED APPLICATIONS

This application claims the benefit of the provisional patent application U.S. App. No. 63/681,469 filed on Aug. 9, 2024, and entitled “Durable Generator Power System and Method of Use,” the entire contents of which are hereby expressly incorporated by reference into the present application

### FIELD OF THE INVENTION

The invention relates to the field of power generators and, more particularly, relates to a long-life modulating generator including both electric fuel and air flow control that is well-suited for use independent of an established electrical supply grid. The invention additionally relates to a method of using such a generator power system.

### BACKGROUND OF THE INVENTION

Electricity generated at a traditional power plant and then transmitted over a power grid is lost in some parts of the world at a rate of nearly 70% by the time the electricity reaches its destination. The United States alone lost approximately 69 trillion BTU worth of power in 2013. In addition to the costs required to develop and maintain the required infrastructure to facilitate long distance electricity transmission, such transmission is neither feasible nor practical in many parts of world because these remote locations are positioned at distances too great from power sources and from each other for the economical transmission of power to them. This problem is particularly prevalent in impoverished regions globally. Without electricity, such regions cannot serve basic human needs, let alone establish any appreciable level of economic activity.

By way of example, in Nigeria, Africa's largest population and highest GDP, over 90 million people lack access to electricity. Without electricity, they lack basic necessities such as lighting or even the ability to drill for water. Nigeria, however, does have a very sophisticated natural gas and propane distribution system, which may be utilized as fuel in power generator systems. Such systems typically include a prime mover, such as an internal combustion engine and an electrical generator that is driven by the engine. However, durability of power generator systems is a significant concern, especially for those located in remote areas that lack access to routine maintenance and service.

A need exists for a durable power generator system, which can be located anywhere, no matter how remote or distant from any other developed infrastructure. The generation of electricity allows for both basic uses such light and water well pumps but also lays the foundation for advanced uses built off of the presence of reliable electricity, such as hospitals, schools, and enhanced economic activity in the form of stores and markets. Electricity is also requisite for advanced communication system, such as internet access, and improved living conditions brought through air conditioning, refrigeration, advanced plumbing systems and sanitation. As the overall quality of life improves through the availability of electricity and the enhancements built thereon.

Additionally, commercial and industrial machinery that requires electricity, may be used in combination with such a durable power generator system in remote field use while requiring less frequent maintenance and/or service.

Traditional power generator systems that are not configured to modulate engine speed based upon the demand of the electrical load may consume significantly more fuel in-part due to their average higher engine operating speed. As a result, such traditional engines typically require a maintenance cycle of approximately 200 hours. Accordingly, such traditional power generator systems are not well configured for use in remote applications that make such routine maintenance feasible.

The need therefore exists to provide a long-life power generator system that modulates engine speed based on electrical load requirements through the use of both fuel and air control for use in off-grid installations while minimizing the occurrence of routine maintenance.

### SUMMARY OF THE INVENTION

In accordance with a first aspect of the invention, a variable speed load matching power generator system for use in an off-grid application may include a genset formed of a liquid cooled variable speed engine and a generator that may comprise an alternator configured to output an electrical supply of between approximately between 0.5 kW and 7.0 kw, and more typically between 4.5 kW and 5.5 kW. The system includes a controller configured to modulate engine speed through variable fuel flow and air flow into the engine and an inverter having a current sensor configured to generate a signal indicative of an electrical demand on the system. The controller further regulates the operating speed of the engine to generate an electrical power output voltage in response to the signal indicative of the electrical load.

In addition, the power generator system may comprise a variable speed engine. The engine may modulate between a running speed or operating speed of approximately 500 RPM to 3,600 RPM and, more typically, 2,400 RPM to 3,400 RPM.

In addition, the power generator system may regulate engine speed to better match the an electrical load placed on the system by the downstream electrical components.

The power generator system may regulate engine speed through a combination of both fuel and air control.

In addition, the power generator system may comprise a battery-powered starting system for starting the genset's engine.

Also disclosed is a method of operating such a power generator system.

These and other aspects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof. It is hereby disclosed that the invention includes all such modifications.

### BRIEF DESCRIPTION OF THE DRAWINGS

Preferred exemplary embodiments of the invention are illustrated in the accompanying drawing in which:

FIG. 1 is a box diagram of a power generation system constructed in accordance with one embodiment of the present invention; and

FIG. 2 is a box diagram of a power generation system constructed in accordance with an alternative embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Also, features or aspects of one embodiment may be combined with features or aspects of an alternative embodiment while remaining within the scope of the present invention.

### DETAILED DESCRIPTION

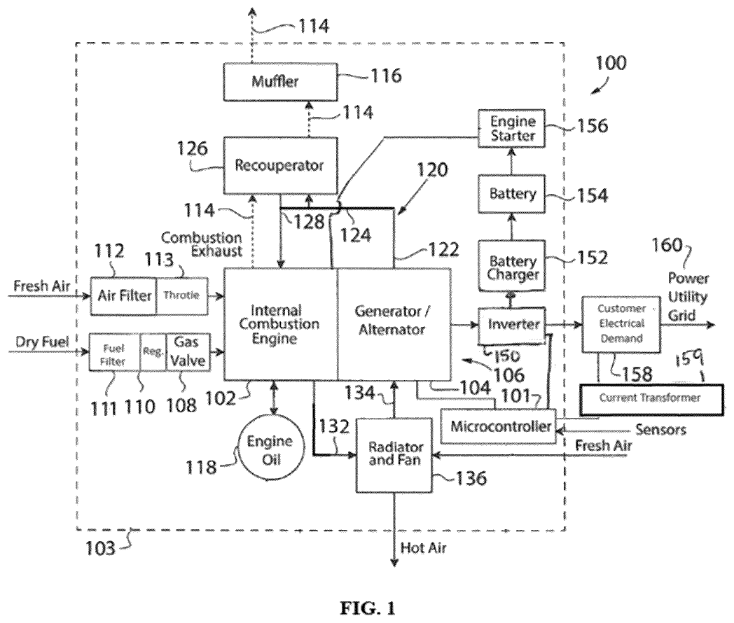

Referring to FIG. 1, a power generational system 100 constructed in accordance with one embodiment of the present invention is shown in schematic form. System 100 can be located off-grid, i.e., it need not be connected to an electrical power grid. The system 100 comprises a generator set or “genset” 106 including an engine 102 and a generator or alternator 104 disposed within a housing 103. System 100 also includes a coolant system 120 configured to progressively heat coolant by heat exchange from the engine 102. A coolant-to-air radiator 136, as described below, is provided for transferring heat from the hot coolant to air. Electricity generated by the system 100 can be used to directly satisfy the downstream energy load(s) or demand(s), charge a battery used to power an electrically powered starter motor for the system's engine, and/or be stored for future use and/or fed into an electrical power grid, if one is present. System operation is controlled by programmable microcontroller 101, wherein signal wires in communication with the microcontroller 101 and components of the system 100 are shown without arrows throughout FIG. 1.

As is typical, the genset 106 includes an engine 102 and a generator/alternator 104. The engine 102 is preferably an internal combustion engine, but may be any alternative form of prime mover. The engine 102 may be a single-cylinder four-stroke, internal combustion natural gas fueled engine and is approximately 8-HP. However, it is considered within the scope of the invention that the engine may be a duel-fuel system that is configured to run on either natural gas or propane with or without requiring mechanical modification to switch between fuels. Both these fuels are widely available in regions lacking reliable electric power grids. Alternatively, the engine 102 may also be a single fuel engine and/or configured to run on any of a variety of fuels such as gasoline, diesel fuel, kerosene, biofuel, etc. More preferably, the engine 102 is configured to have a long-running lifespan of greater than approximately 40,000 operating hours and has relatively low maintenance requirements, with maintenance intervals of approximately 4,000 hours to 8,000 hours, and more preferably at least 6,000 hours. Such a long run life and relatively infrequent maintenance, due in part to its modulating run speed that allows the engine 102 to vary run speed to match electrical demand 158 while providing a steady rate of electrical generation as well as the combination of both electrical control of fuel and air supply into the engine 102, is of significant importance in geographically remote applications of the power generation system 100, where routine service may be infrequent.

The engine 102 is preferably a variable speed engine. Accordingly, modulating the running speed of the engine 102 between preferably approximately 1,200 RPM to 3,600 RPM results in a corresponding electrical power generation of approximately between 0.5 kW and 7.0 kW, respectively. As a result of modulating the speed of the engine 102 under direct or indirect control of the microcontroller 101, the genset's electrical output can be varied to meet or follow the electrical load placed on the power generation system 100, thereby maximizing efficiency of the system 100 as compared to a traditional fixed speed engine having a 2 pole or 4 pole alternator.

Operation of the engine 102 between approximately 2,400 RPM to 3,400 RPM to drive the alternator 104 to generate approximately between 4.5 kW and 5.5 kW may result in between 5,000 and 50,000, and, more typically, between 13,000 and 43,000 BTUs of heat transferred to the coolant system 120. However, it should be considered well within the scope of the present invention that the engine 102 and the genset 106 as a whole may be of larger capacity such that the internal combustion engine 102 may further provide approximately: 10 to 40 kW.

Fuel is supplied to the engine 102 at a variable rate via a microcontroller 101 regulated gas valve 108 and regulator 110, which controls the flow of fuel into the engine 102. A fuel filter 111 may optionally be installed upstream of the gas valve 108 and regulator 110. Atmospheric air is supplied to the engine 102 through an air filter 112 and subsequently microcontroller 101 regulated throttle 113 at a variable rate that is typically of approximately 15 to 20 cubic feet per minute, depending upon engine speed. Heated exhaust gases exit the engine 102 through an exhaust system 114, which may have a muffler 116, and optionally a recuperator 126 disposed therein.

In one embodiment, the engine 102 may operate with variable throttle positions. As a result of this operating condition, the throttle acts as a restriction to the air flow into the engine cylinder when the electrical demand on the power generation system 100 decreases and engine speed is lowered. Such a restriction on air flow independently may result in a variable volumetric inefficiency of the engine 102. Accordingly, in the present a system, an oxygen sensor (not shown) positioned within the exhaust system 114, which is in electrical communication with the microcontroller 101 is also provided to determine the proper fuel/air ratio necessary to operate the engine 102 at the appropriate speed in order for the generator/alternator 104 to output an electrical current that matched downstream electrical demand. In such a system 100, the electrical output from the system 100 is controlled by the inverter 104 which may be configured to match the electrical demand 158 placed on the system 100 and/or divert electrical power in excess of the electrical load to a storage system as will be described in further detail below. This combination of electrical control of both the air flow and fuel flow provides for reduced emission output through the exhaust system 114 and a prolonged maintenance cycle. In one embodiment, the engine 102 may forgo the use of a catalyst in the recuperator 126, which is traditionally required for meeting CO₂ and NO emissions level, in lieu of the combined fuel air controlled engine 102.

During operation, the engine 102 is lubricated via engine oil delivered from an oil reservoir 118 and circulated between the engine 102 and the oil reservoir 118 via a pump (not shown). A coolant system 120, comprising a series of conduits 122, 124, 128, 132, 134, that extend from the engine 102 and alternator 104 as to allow coolant to flow throughout the system 100, thereby reducing the operating temperature of the engine 102 and alternator 104. More specifically, coolant enters the alternator 104 wherein operation of the alternator 104 heats the coolant to an elevated temperature. The coolant then flows from an outlet 122 of the alternator 104 indirectly or directly to radiator and fan 136 or heat exchanger. Heat from the engine oil contained within the reservoir 118 may also be transferred to the coolant, and in turn the radiator 136 or heat exchanger, thereby reducing the temperature of the engine oil in the oil reservoir 118.

During use, the exhaust traveling from the engine 102 to the muffler 116 and through the exhaust outlet 114 may pass through an exhaust catalyst such as a catalytic converter or other exhaust treatment device as to reduce toxic gases and pollutants in the exhaust gas prior to entering the muffler 116. As discussed above, the oxygen sensor that provides data used by the microcontroller 101 for controlling the fuel-to-air ratio of the engine 102 is similarly disposed within the exhaust system.

Returning now to the genset 106, as was described above, operation of the engine 102 generates rotational mechanical energy to power generator/alternator 104 to generate an AC electric current. As illustrated in FIG. 1, the AC current from the generator/alternator 104 is transmitted through an electrical conductor to an inverter 150, where the alternating current is converted to direct current and back to the desired DC output. A first portion of the current may be directed through a battery charger 152, which in turn charges a starter battery 154, such as a 12V battery. In one embodiment the batter charger 152 is integral with the inverter 150. Upon initial start-up of the power generation system 100, the battery 154 supplies power to an electric engine starter 156, which cranks the engine 102 so as to initiate operation of the engine 102 under its own power. A battery boost converter or Dc-to-DC step-up converter integral with the inverter may create a 60V output from the 12V battery 152 for use in engine starting. By providing an electric starter 156 that is charged through operation of the genset 106, the power generation 100 does not need to rely upon a central power grid or other external power source in order to start the power generation system 100. Accordingly, the power generation system 100 according to the present invention is well-suited for operation in geographic regions that lack either a central power grid or a dependable electrical distribution network. To this end the inverter 150 may convert the high voltage DC output from the generator 102 to 240V AC power, and more specifically a 24/120 split phase electrical power for use in standalone or off-grid applications common in North America, or alternatively to three phase electricity for us in industrial and commercial settings, or single phase in residential settings.

Alternatively, the power generation system 100 according to the present invention may be connected to a power grid 160, but is configured to operate independently in the event of an interruption of electrical supply provided through the power grid.

In yet another alternative embodiment in which the power generation system 100 is operated while connected to a central power grid, the inverter 150 may direct current from the grid into the engine starter 156 directly, in order to turn the engine 102 over.

In one embodiment of the preset invention, starting the genset 106 is controlled by the microcontroller 101, which allows for a gentler speeding up and starting of the engine 102, thereby reducing fatigue on the engine 102. For example, if the engine 102 is stopped near top dead center of a compression stroke, substantially higher torque would be required to start turning the engine 102 over. The microcontroller 101 may detect the position of the cylinder, for example through the use of a cam sensor, and then reverse the engine 102 approximately ¾ of a cycle, as to reduce the energy required to start the engine near a power stroke.

Referring again to FIG. 1, current in excess of that needed to charge the battery is made available for use and/or storage. The microcontroller 101 may operatively control the speed of the system 100 by way of matching the electrical load on the genset 106 to the power output reading at the inverter 150, thereby allowing the engine 102 to operate at a lower or variable speed when possible, as to improve fuel efficiency and elongate maintenance cycles. The electrical load placed on the system 100, is measured at a current sensor in communication with the microcontroller 101. Based on the received signals, the microcontroller 101 may then correspondingly modulate the operating speed of the engine 102 such that the electrical output from the alternator 104 matches the electrical load as detected at the electrical panel 158, or other downstream current demand.

In one embodiment of the present invention, as shown in FIG. 1, the generated electrical current is directed to downstream to supply power to one or more electrical components, such as but not limited to a building's electrical panel or other electrical demand 158, where it can either be used to meet the building's electrical demand or provided back to a power grid 160 (if present) when the generated current exceeds the electrical load.

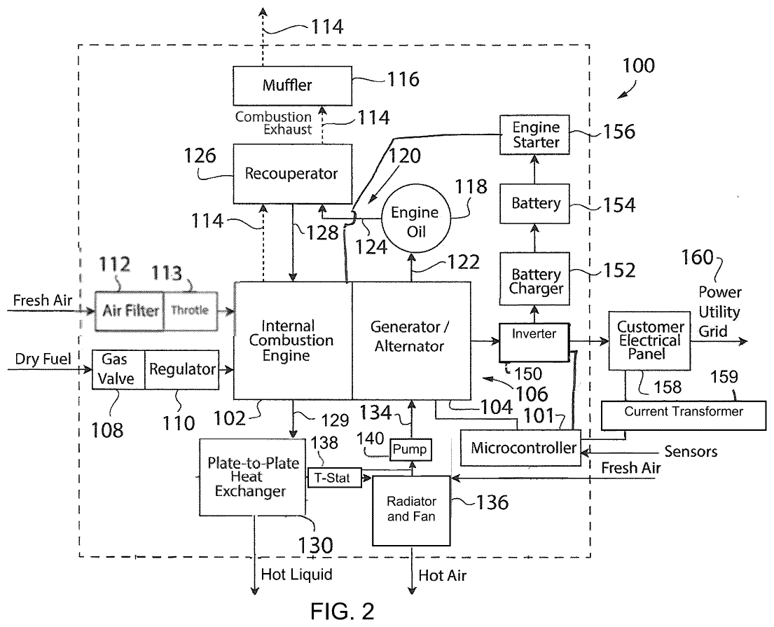

Turning now to FIG. 2, an alternative embodiment of system 100 is illustrated, including a modified coolant loop 120, comprising a series of conduits, extends from the engine 102 and alternator 104 as to allow coolant to flow throughout the dual-fuel variable speed generator system 100, thereby reducing the operating temperature of the engine 102 and alternator 104 and simultaneously recapturing waste heat for heating a liquid or water source, such that it operates a cogeneration system, as will be described in further detail below. More specially, in the coolant loop 120, coolant enters the engine 102 at a first temperature of, for example, approximately 148° F. Operation of the engine 102 heats the coolant to a second temperature that is greater than the first temperature. The coolant then flows from the engine to the liquid cooled alternator 104, where the coolant is further heated to a third temperature that is higher than the second temperature. Heated coolant then flows out an outlet 122 of alternator 104 to an oil cooler 118, such as a liquid-to-liquid heat exchanger, that draws heat for the oil and elevates the coolant to a fourth temperature that is greater than the third temperature. This heat transfer reduces the temperature of the engine oil in the oil cooler or reservoir 118. Meanwhile, the heated coolant passes from the oil reservoir 118 via a conduit 124 and flows into a gas-to-liquid heat exchanger such as a thermal recuperator 126. The recuperator 126 may be a shell and tube exchanger comprising a liquid coolant filled shell containing a series of tubes through which the heated exhaust may travel.

However, alternative heat exchanger configurations are within the scope of the present invention.

During use, the heated exhaust gases traveling from the engine 102 to the muffler 116 and through the exhaust outlet 114 pass through the tubes of the recuperator 126, heating the coolant flowing through the surrounding shell component to a fifth temperature.

An exhaust catalyst for reducing emissions in the exhaust may optionally be disposed at or in the recuperator 126 or elsewhere in the exhaust system, along with an oxygen sensor (not shown) that provides data used by the microcontroller 101 for controlling the fuel-to-air ratio of the engine 102. In this configuration, the recuperator 126 may also contain a catalytic converter or other exhaust treatment device as to reduce toxic gases and pollutants in the exhaust gas prior to entering the muffler 116.

The coolant at the fifth temperature, typically, approximately 155° F. to 175° F., and more preferably approximately 168° F., then travels from the recuperator 126 through inlet 129 and into a liquid-to-water heat exchanger 130, such as a plate to plate heat exchanger. However, other exchangers such as shell and tube, plate and fin, and microchannel exchangers are well within the scope of the present embodiment. At the exchanger 130, heat from the coolant, is transferred to a liquid such as water. This heat transfer may reduce the temperature of the coolant by approximately 15° F. to 25° F., and more preferably approximately 20° F., while simultaneously recapturing the waste heat in the elevated temperature of the water for use external to the dual-fuel variable speed generator system 100, such as a domestic hot water supply.

In one embodiment, the heated coolant enters the heat exchanger 130 at a temperature of approximately 168° F. and exits the heat exchanger 130 at a lower temperature of approximately between 148° F. A thermostat 138 may read the temperature of the coolant exiting the heat exchanger 130 and selectively alter the coolant to a pump 140 for redistribution throughout the coolant loop 120, if the coolant temperature is sufficiently low. Alternatively, a radiator and fan assembly 136 may be disposed in lie with the outlet from the heat exchanger 130, as shown in FIG. 2. In the event that the heat transfer at the exchanger 130 is insufficient to reduce the temperature of the coolant to a temperature at or near the first temperature, additional excess heat may be removed from the coolant via the radiator and fan assembly 136 that passes atmospheric air through the radiator 136 to dissipate excess heat. The fan of the assembly 136 need not be continually activated but rather can be selectively activated in response to the temperature of the coolant output from the exchanger 130 sufficiently exceeding the first temperature. The coolant may then return to the the genset 106 via coolant inlet 134, thereby completing and then restarting the coolant loop 120.

A coolant pump 140, disposed at or near the genset coolant inlet 134, continues to circulate the coolant through coolant loop 120 as generally described above, and may also be controlled by the thermostat 138, as to maintain optimal operating temperature for the genset 106, and further elongate maintenance or service cycle duration, i.e., oil changes.

In another embodiment of the present invention in which the power generation system 100 may or may not be independent of an electrical grid, excess electricity may be stored for subsequent use in a single battery, a battery array, fuel cells, etc.

In still another alternative embodiment of the present invention, two or more power generation systems 100 may operate in tandem to provide a combined electrical output to a plurality of electrically powered components or buildings, where the two or more power generation systems 100 generate a sufficient electrical power to meet the cumulative electrical load of the multiple components and/or buildings.

In yet another alternative embodiment, one or more power generation systems 100 according to an embodiment of the present invention may be integrated into a microgrid (not shown), i.e., a decentralized group of electricity sources and loads that may function when disconnected from or entirely independent of a central power grid. The microgrid may comprise a plurality of discrete electrically powered components and/or buildings, where each or many buildings include a corresponding power generation system 100 as generally described above.

In this configuration, the electricity generation of multiple power generation systems 100 may be distributed to various discrete electrically powered components and/or buildings in the microgrid as to meet the electrical demand of the microgrid system. Such a system may further include additional sources of electrical generation, including solar generated electricity, wind generated electricity, hydrogenated electricity etc. Furthermore, excess electricity generated from the various sources within the microgrid, which exceeds demand, may be stored for subsequent use in a single battery, a battery array, fuel cells, etc. Alternatively, the excess electricity may be sold back to a central power grid, if the microgrid is connected to a central power grid. In such an embodiment, where the microgrid provides multiple sources of electricity generation, the failure of a single source of electricity generation, such as a single power generation system 100 will not result in either a loss of electricity at the building associated with the power generation system 100 or a system-wide failure, as the remaining sources of electricity generation throughout the microgrid may be relied upon to provide continued generation and distribution of electricity.

In yet another alternative embodiment, one or more power generation systems 100 according to the present invention may provide an electrical power supply in combination with one or more additional electrical generation sources, such as solar generated electricity, wind generated electricity, hydrogenated electricity, etc.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A variable speed load matching power generation system that is configured to provide electrical power, comprising:
a genset comprising a dual-fuel, liquid-cooled, variable speed engine and a liquid cooled alternator and being configured to output an electrical supply of between approximately between 1.5 kW and 7.0 kW;
a controller configured to modulate engine speed through variable fuel flow and air flow into the engine;
an inverter in electrical communication with a current sensor configured to generate a signal indicative of an electrical demand on the system;
wherein the controller is configured to electrically regulate the operating speed of the engine to generate an electrical power output voltage in response to the signal indicative of the electrical load; and
wherein the power system lacks a connection to an external central power grid.

2. The system of claim 1, wherein the engine of the genset comprises a variable speed engine configured to be modulated between an operating speed of approximately 500 RPM to 3,600 RPM.

3. The system of claim 2, wherein the controller is configured to electrically regulate the operating speed of the engine to match engine power output to an electrical demand place on the system.

4. The system of claim 3, wherein the controller is configured to electrically modulate the engine speed by regulating both air flow through the throttle within a rate of between 15 to 20 cubic feet per minute, and fuel flow through a fuel regulator.

5. The system of claim 4, wherein the system is configured to conform to CO2 and NO emissions level requirements via electrically regulated air and fuel modulation in the absence of an exhaust catalyst downstream of the engine.

6. The system of claim 3, wherein the alternator is a permanent magnet alternator.

7. The system of claim 1, wherein the dual-fuel, liquid-cooled, variable speed engine is natural gas or propane fueled.

8. The system of claim 7, wherein the dual-fuel, liquid-cooled, variable speed engine can be alternatively fueled by either natural gas or propane without system modification.

9. The system of claim 3, wherein the dual-fuel, liquid-cooled, variable speed engine is a single cylinder, four stroke, variable speed engine.

10. The system of claim 9, wherein the dual-fuel, liquid-cooled, variable speed engine is an approximately eight horsepower engine.

11. The system of claim 1, wherein the system has an average maintenance cycle of approximately 4,000 operating hours to 8,000 operating hours.

12. The system of claim 1, further comprising a battery-powered engine starting system coupled to the engine of the genset.

13. The system of claim 1, wherein the system is disconnected from any electrical grid.

14. The system of claim 1, wherein the genset is configured such that a portion of the electrical supply of between approximately between 1.5 kW and 7.0 kW generated by the genset is provided to an electrical storage device.

15. A method of operating a variable speed load matching power generation system, comprising the steps of:
providing an electrical grid independent genset comprising a dual fuel, variable speed liquid cooled engine and a liquid cooled alternator;
a current sensor generating a signal indicative of an electrical demand on the system;
transmitting the signal from the sensor to a controller via an inverter;
the controller electrically modulating a throttle position and fuel supply to electrically regulate the operating speed of the engine between 500 RPM to 3,600 RPM to generate an electrical power output voltage of between 1.5 kW and 7.0 kW in response to receiving the signal indicative of the electrical load; and
wherein the power system lacks a connection to an external central power grid.

16. The method of claim 15, further comprising the variable speed load matching power generation system matching the electrical power output to the electrical demand sensed at the inverter.

17. The method of claim 16, further comprising, using the variable speed load matching power generation system generating an electrical current output in excess of the electrical demand sensed at the inverter.

18. The method of claim 16, further comprising modulating the throttle position based in-part upon a signal generated at an oxygen sensor positioned without the exhaust of the engine.

19. The method of claim 16, further comprising starting the variable speed load matching power generation system with a battery-powered engine starting system coupled to the engine of the genset, wherein the inverter charges a starter battery during operation of the variable speed load matching power generation system.

20. The method of claim 16, further comprising
harvesting waste heat from the variable speed load matching power generation system by heating coolant disposed within a coolant loop from an initial temperature to an elevated temperature via heat transfer from the liquid cooled genset;
passing the heated coolant in the coolant loop through a coolant-to-liquid heat exchanger; and
heating a liquid disposed within a liquid circuit at the coolant-to-liquid heat exchanger via heat transfer from the coolant in the coolant loop.
